(19) United States
(12) Patent Application Publication
(10) Pub. No.: US 2018/0231177 A1
(43) Pub. Date: Aug. 16, 2018

(54) Remote Radio Head Mounting

(71) Applicant: Nokia Solutions and Networks Oy, Espoo (FI)

(72) Inventor: Juho Tuovila, Oulu (FI)

(21) Appl. No.: 15/434,782

(22) Filed: Feb. 16, 2017

(51) Int. Cl. F16M 13/02; F16M 11/20; H01Q 1/12; H01Q 1/24

(52) U.S. Cl. CPC F16M 13/022; F16M 11/2085; F16M 2200/028; H01Q 1/246; H01Q 1/1228

(57) ABSTRACT

An apparatus including a mount and a mounting bracket. The mount includes an elongate extruded member, where the elongate extruded member which has a rail along a length of the extruded member. The mounting bracket is configured to have a remote radio head (RRH) connected thereto. A top side of the rail is configured to form a first portion of a hinge. A top end of the mounting bracket is configured to form a second portion of the hinge. The top end of the mounting bracket is configured to be placed on the top side of the rail to form the hinge and the hinge is configured to allow the mounting bracket to be rotated down on the rail to a mounting position of the mounting bracket on the mount.

### BACKGROUND

### Technical Field

The exemplary and non-limiting embodiments relate generally to a mounting for a remote radio head.

### Brief Description of Prior Developments

It is known to locate a remote radio head (RRH) relative to one or more other remote radio heads (RRHs) such that, if the remote radio head (RRH) needs to be replaced, the remote radio head (RRH) may be replaced without interfering with the functionality of the other remote radio heads (RRHs).

### SUMMARY

The following summary is merely intended to be exemplary. The summary is not intended to limit the scope of the claims.

In accordance with one aspect, an example embodiment is provided in an apparatus comprising a mount comprising an elongate extruded member, where the elongate extruded member comprises a rail along a length of the extruded member; and a mounting bracket configured to have a remote radio head (RRH) connected thereto; where a top side of the rail is configured to form a first portion of a hinge, where a top end of the mounting bracket is configured to form a second portion of the hinge, and where the top end of the mounting bracket is configured to be placed on the top side of the rail to form the hinge and the hinge is configured to allow the mounting bracket to be rotated down on the rail to a mounting location of the mounting bracket on the mount.

In accordance with another aspect, an example method comprises providing an elongate extruded member, where the elongate extruded member comprises a rail along a length of the extruded member, where the rail comprises a top side configured to form a first portion of a hinge; and providing a mounting bracket configured to have a remote radio head (RRH) connected thereto, where a top end of the mounting bracket is configured to form a second portion of the hinge, where the top end of the mounting bracket is configured to be placed on the top side of the rail to form the hinge and the hinge is configured to allow the mounting bracket to be rotated down on the top side of the rail to a mounting position of the mounting bracket on the mount.

In accordance with another aspect, an example method comprises locating a top end of a mounting bracket on a mount, where the mounting bracket has a remote radio head (RRH) connected thereto, where the mount comprises an elongate extruded rail, and where the top end of the mounting bracket it located on a top side of the extruded rail such that the top side of the extruded rail forms a first portion of a hinge and the top end of the mounting bracket forms a second portion of the hinge; and rotating the mounting bracket relative to the mount at the hinge such that the mounting bracket is rotated down on the top side of the extruded rail to a mounting position of the mounting bracket on the mount.

### BRIEF DESCRIPTION OF THE DRAWINGS

The foregoing aspects and other features are explained in the following description, taken in connection with the accompanying drawings, wherein:

FIG. 1 is a diagram illustrating a base station;

FIG. 2 is a diagram illustrating an example embodiment;

FIG. 3 is a partial perspective of the embodiment shown in FIG. 2 without showing the remote radio heads;

FIG. 4 is a cross sectional view of the embodiment shown in FIG. 3 taken along line 4-4;

FIG. 5 is a partial end view of the embodiment shown in FIGS. 2-3;

FIG. 6 is a partial end view of one of the components shown in FIGS. 3 and 5;

FIG. 7 is a diagram illustrating the initial connecting the mounting bracket to the mount shown in FIGS. 3 and 5;

FIG. 8 is a diagram as in FIG. 7 illustrating a final connection location of the components shown in FIG. 7;

FIG. 9 is a diagram illustrating a horizontal interlock of the apparatus shown in FIG. 3;

FIG. 10 is a diagram similar to FIG. 9 illustrating an alternate example of a horizontal interlock;

FIG. 11 is a diagram similar to FIG. 9 illustrating an alternate example of a horizontal interlock;

FIG. 12 is a diagram as in claim 6 illustrating an alternate example of a snap-lock latch;

FIG. 13 is a partial cross sectional view of an alternate example of the elongate extruded member;

FIG. 14 is a diagram of an example method; and

FIG. 15 is a diagram of an example method.

### DETAILED DESCRIPTION OF EMBODIMENTS

Referring to FIG. 1, there is shown a system 10, such as a base station for example, comprising antennas 12 and remote radio heads (RRHs) 14. In the system 10 shown, the antennas 12 and remote radio heads (RRHs) 14 are mounted on a frame 16, such as a tower for example, and the system further comprises remote radio cable assemblies 18, multiport fiber terminals 20, vertical fiber cables 22, and base transceiver stations 24. The RRHs 14 use the antennas 12 to send and receive radio signals. The system shown in FIG. 1 is merely an example to better understand the description below and should not be considered as limiting features as described herein. The system 10 may be used for communicating, via radio frequencies, to other devices, such as the user equipment (UE) 26 shown in FIG. 1. The base station may be connected to other wired and/or wireless network equipment (not shown).

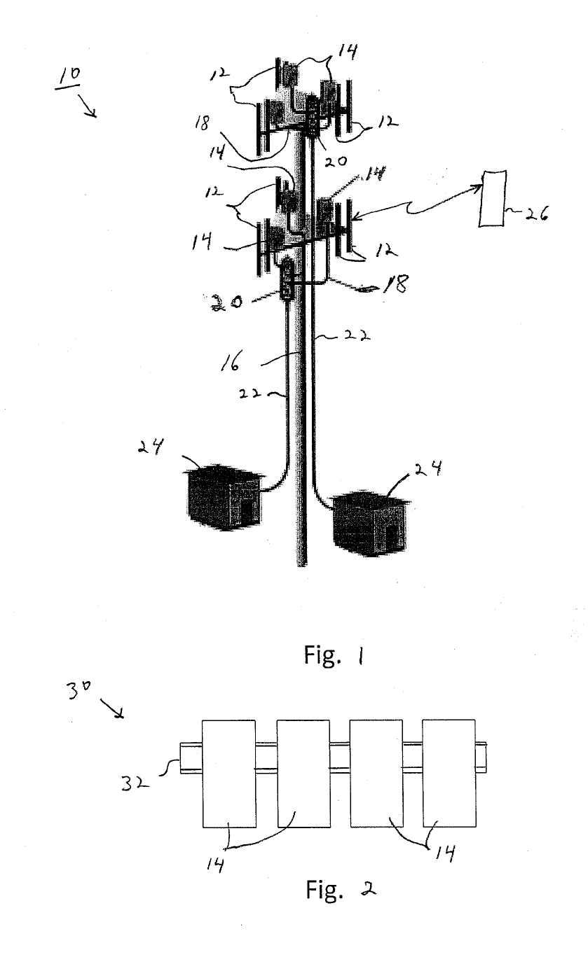

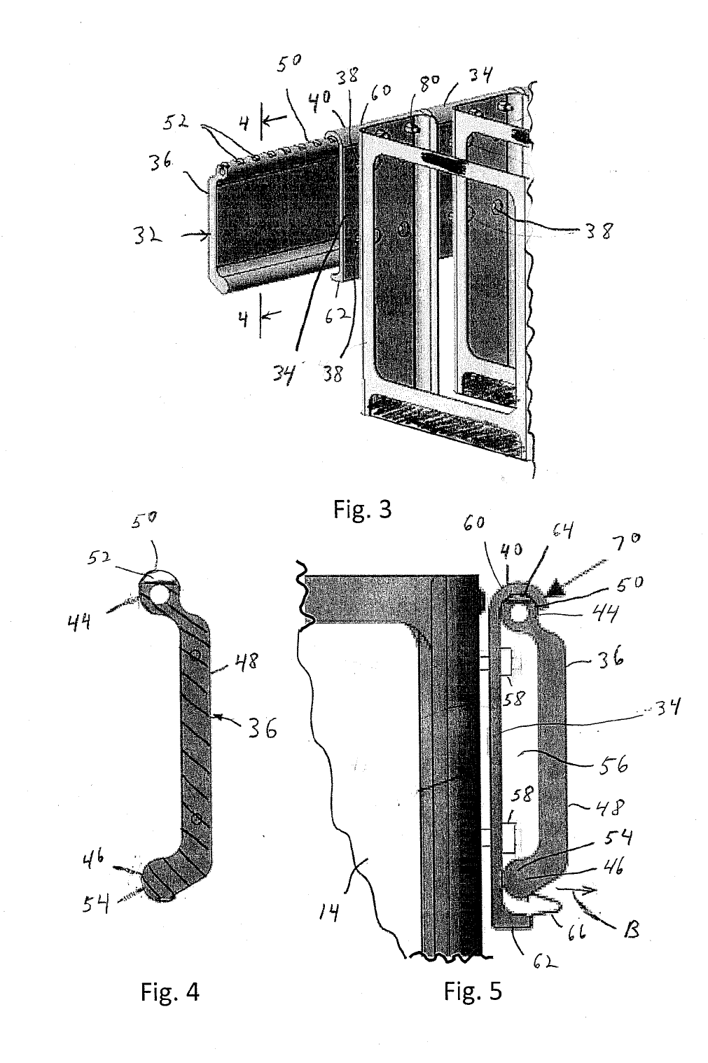

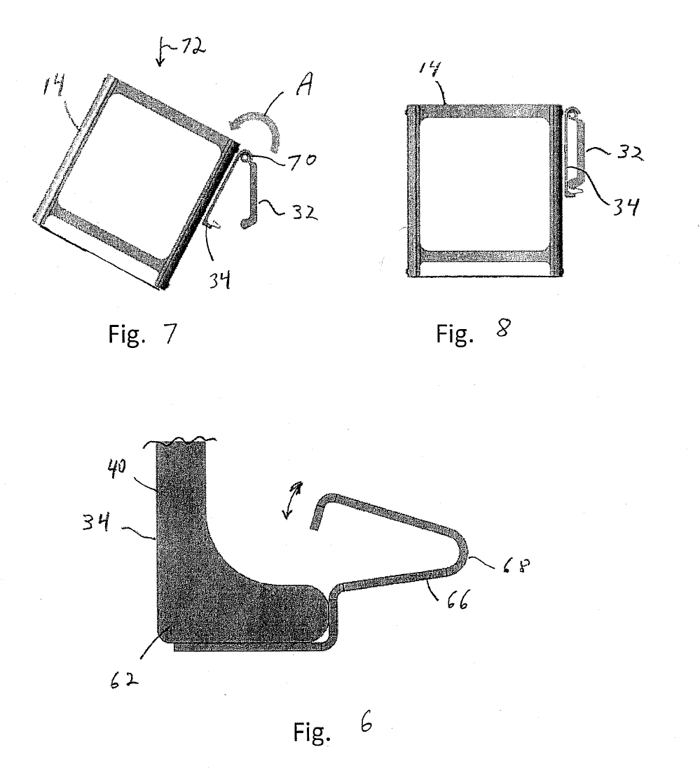

Referring also to FIG. 2, a system 30 is shown incorporating features of an example embodiment. Although the features will be described with reference to the example embodiments shown in the drawings, it should be understood that features can be embodied in many alternate forms of embodiments. In addition, any suitable size, shape or type of elements or materials could be used. The system 30 is provided to enable mounting of one or more of the remote radio heads (RRHs) 14 to another member, such as the frame 16 shown in FIG. 1 for example. In this example the system 30 has four (4) RRHs. However, in alternate examples, more or less than four (4) RRHs may be provided.

Referring also to FIGS. 3-5, the system 30 includes a mount 32 and one or more mounting brackets 34. The mount 32 comprises a one-piece member 36 which has an elongate shape, such as formed as an extruded member for example. For example, the member 36 may be a one-piece elongate extruded aluminum member. The mount 32 may include fasteners (not shown) to fixedly attach the elongate member 36 to another member, such as the frame 16 for example. The elongate member 36 is configured to form a fixing rail for the RRHs. As another example, the elongate member 36 may be fastened on a wall using screws as the fasteners.

After the mount 32 is attached to the frame or wall, one or more of the mounting brackets 34 may be used to mount one or more of the RRHs 14 on to the mount 32. In one example the mounting bracket 34 is attached to one of the RRH 14 using four screws or fasteners at the holes 38 in the bracket 34, such as fasteners 58 shown in FIG. 5 for example. In FIG. 3 the remote radio heads (RRHs) 14 are shown cut away to illustrate their mounting holes which align with the holes 38. In the example shown, the mounting bracket 34 comprises a rail mounting piece 40. With the RRH 14 attached to the mounting bracket 34, when the end user is ready to place the RRH 14 on the mount 32, in this example the user merely needs to place the mounting bracket and RRH assembly 34/14 onto the mount 32 as further described below.

As seen best in FIG. 4, the elongate extruded member 36 has a top end 44, a bottom end 46 and a connecting middle section 48 between the top and bottom ends 44, 46. The top end 44 has a generally curved or bulbous shaped cross section and extends from the middle section 48 to form a first rail 50 along the longitudinal length of the elongate member 36. In this example, in addition to the top end 44 having a generally curved or bulbous shaped cross section, apertures or slots 52 are provided into the top surface of the top end 44. For example, the apertures 52 may be machined into the first rail 50 after the member 36 has been formed by extrusion. However, in an alternate example these apertures 52 might not be provided. In this example the bottom end 46 also has a generally curved or bulbous shaped cross section and is configured to extend from the middle section 48 to form a second rail 54 along the longitudinal length of the elongate member 36. However, in an alternate example the bottom end 46 could have an alternate different shape. In this example, because the two rails 50, 54 extend in a generally same direction away from the middle section 48, this is configured to form an open area 56 (see FIG. 5) when the mounting bracket 34 is attached to the mount 32. This open area 56 is configured to accommodate ends of the fasteners 58 used to attach the mounting bracket 34 to the RRH 14.

The rail mounting piece 40 of the mounting bracket 34 comprises a top end 60 and a bottom end 62. The rail mounting piece 40 may be made from stamped and formed sheet metal or may be extruded or molded. In this example, the rail mounting piece 40 is an extruded member. In this example, a separate rail mounting piece 40 is provide for each respective RRH 14. In an alternate example embodiment the rail mounting piece 40 may be configured to mount more than one RRH thereto. The top end 60 is curved to form a general cross-sectional “C” shape. This forms an inner curved surface 64. This inner curved surface 64 is sized and shaped to receive the top side of the first rail 50 therein. The rail mounting piece 40 is sized and shaped such that, when the mounting bracket 34 is attached to the mount 32, the bottom end 62 extends below the second rail 54 as shown in FIG. 5.

Referring also to FIG. 6, in this example the mounting bracket 34 also includes a snap-lock latch 66. In this example the snap-lock latch 66 comprises a sheet metal member 68 attached to the rail mounting piece 40 and shaped to form a resilient spring. The snap-lock latch 66 is configured to resilient deflect under the bulbous shape of the second rail 54 and snap-lock behind the bulbous shape. However, in alternate example embodiments other types of latches or locks could be provided.

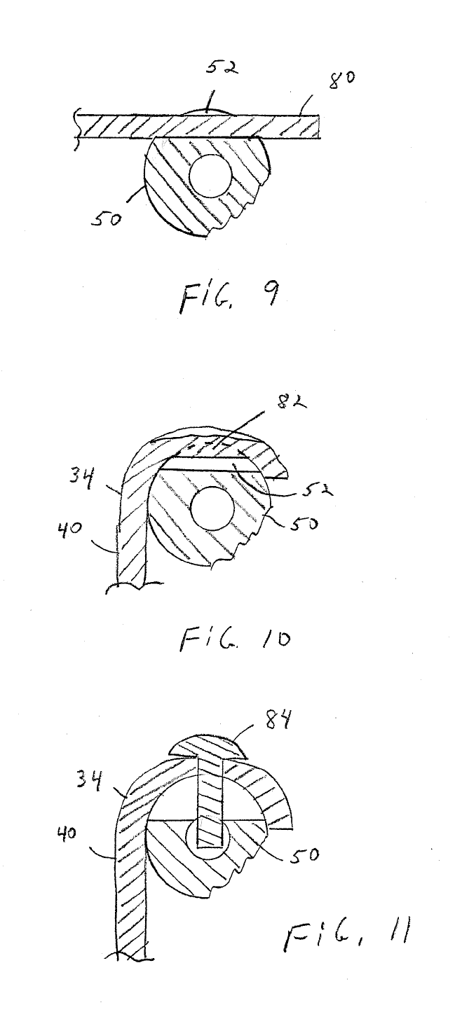

Referring also to FIGS. 7-8, FIG. 7 shows how the mounting bracket 34 is initially mounted to the mount 32 and then subsequently rotated, as indicated by arrow A, to a final mounting location or position on the mount 32. With the locating of the top end 60 of the rail mounting piece 40 onto the first rail 50 as shown in FIG. 7, the joint of the rail and the bracket will form a hinge 70. The hinge 70 and earth gravity 72 will guide the user towards the locking mechanism 66 being engaged. By assistance of gravity 72 the user may merely press the mounting bracket 34 (with RRH 14 attached) towards the mount 32 and, with the snap-lock latch 66, the user may hear a solid “click” audio sound as the latch 66 snaps behind the second rail 54. To ensure the locking mechanism functionality in all weather conditions, the user may optionally place a securing pin though the locking/latching mechanism.

One of the features of the example described above is in regard to the number of parts needed to fix one or more RRHs on a mount. By reducing needed items, compared to conventional RRH mounting schemes, the fixing features described herein will be cost effective, and will also provide an easy to use user installation experience. Features as described herein will also reduce installation time compared to conventional mounting systems where multiple screws are needed to make a connection. The fixing rail may be done using a simple extruded aluminum profile; as well the unit bracket being a simple extruded aluminum profile for example.

In the example described above, the system also comprises an interlock configured to prevent horizontal movement of the mounting bracket 34 on the mount 32 after the mounting bracket 34 is attached to the mount 32. In this example one or more of the apertures 52 may be used to receive one or more projections from the mounting bracket 34 to limit horizontal movement. For example, FIG. 9 shows an example of a fastener 80 attached to the mounting bracket 34 extending into one of the apertures 52 as a horizontal interlock. The fastener 80 functions as a projection into the aperture 52. The horizontal movement along the rail may, thus, be prevented by a machined feature 52 on the extruded alloy member 36. As another example, FIG. 10 shows the rail mounting piece 40 with a projection 82 integrally formed therein to match the machined feature 52 on the rail. The profile can be machined or, as seen also with FIG. 11 for example, a pin 84 may alternatively be installed to prevent horizontal movement. By providing the apertures 52 suitably spaced apart, this may also be used to guide the user to select a spacing between the units; to prevent the possibility of installing units too close together without adequate thermal spacing.

The locking mechanism in the example noted above includes the snap-lock latch 66 which may be a sheet metal spring that is mounted below a part of the mounting bracket. The sheet metal spring may be assembled to the rail mounting piece 40 using screws or any other available fastening method. Using removable screws would help to allow replacing the spring if seen necessary.

When the hinge joint 70 between the first rail 50 and bracket 34 is made, the extruded members 36, 40 may be against each other when the unit is resting on the rail as seen in FIG. 7. The locking spring 66 on the mounting bracket may subsequently lock on the back of the fixing rail 54 as seen in FIGS. 5 and 8. The spring 66 may create a force which pulls the unit 34/14 against the rail as seen by arrow B, and the hinge 70 on the top will carry the unit load. When the end user wants to replace the unit 34/14, the user may merely pull the unit 34/14 upright according to the hinge movement, reverse to arrow A, to disengage the spring clip 66. This reverse movement may require more force than installing the unit 34/14.

Use of a snap-lock spring as the locking mechanism provides a simple and easy feature. The spring element may be easy to replace or remove if the unit is stuck on the rail 54; merely unscrew the spring 66 from the piece 40 for example. Also, sheet metal parts are relatively inexpensive to manufacture, and the springs 66 can be customized to different sized units if desired. Spring loads may be selected by merely selecting a different spring size or shape and not having to deal with changing the extrusion process for the piece 40. With features as described above, since the space below the mount 32 is empty, this provides a good location to provide the latching for the latch 66 without a need for additional latch accommodating space to be designed into the pieces 36, 40. However, in an alternate example embodiment the latch may be located to latch in the space 56 on the top side of the second rail 54. The snap-lock latch could alternatively be integrally formed with the piece 40 and/or the member 36; perhaps with additional machining. With features as described above, the unit bracket may contain only the hinge, and the sheet metal spring can be fastened on the lower end of the bracket by any common fixing method.

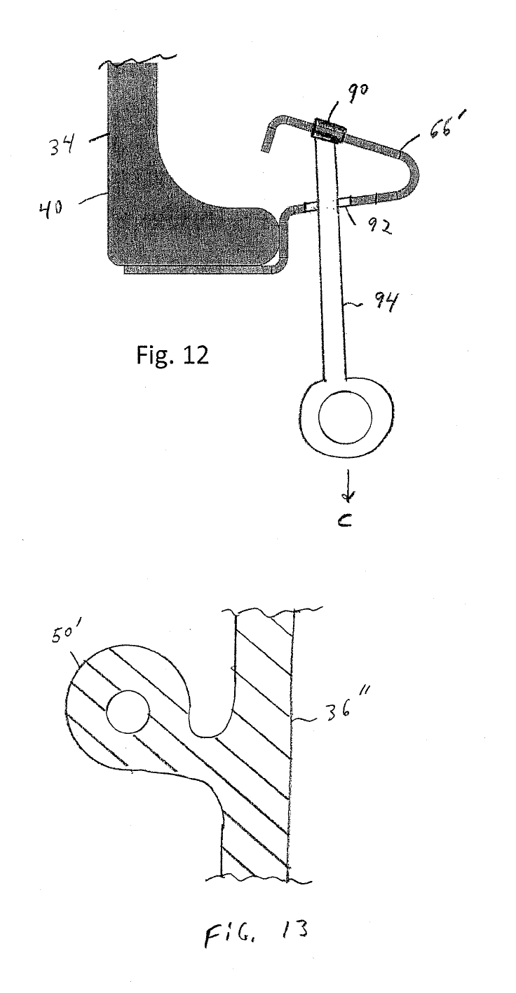

In another example, it is possible to implement feature that is configured to help remove a unit 34/14 from a mount. As shown by the example in FIG. 12, the sheet metal spring may have a loop 90 and hole 92 on the locking feature. A wire or strap 94 can be fastened into the loop 90. The wire or strap 94 may be pulled through the hole 92 as indicated by arrow C. This wire or strap 94 may hang on below the unit bracket locking mechanism. When the wire or strap is pulled, it would pull the locking spring 66′ to help to unlock the unit.

Features as described herein may be used with a mechanical design for an outdoor fixing solution. Features as described herein may be used with extruded aluminum profiles in conjunction with a sheet metal locking system. With features as described herein, manufacturability and the number of parts may be minimized, but with still maintaining options for customization and various use cases.

With features as described herein, RRHs units 14 may be placed on a fixing rail, where each unit may be able to be replaced without distracting other functional units 14. The fixing solution is easy to use, but cost effective from manufacturability and an assembly point of view. With features as described herein, assembly time may be minimized without risking reliability of the locking mechanism.

In one convention design, RRHs are fixed on a wall using at least four screws. Some manufacturers have specific fixing elements where screw count can be minimized, but extra, parts are needed. Some solutions for fixed use only one screw, but the screw location is usually challenging from usability point of view, such as when the screw needs to be accessed with a tool from underneath the radio unit. With features as described herein, to be able to provide the best user experience, an example embodiment does not have too many parts; which helps to prevent the possibility of a mistake during assembly.

FIG. 13 shows another alternate example of the elongate extruded member 36″. In this example the first rail 50′ is not located at the top of the member 36″. The member 36″ could have multiple first rails 50 stacked one above the other.

An example embodiment may be provided in an apparatus comprising a mount comprising an elongate extruded member, where the elongate extruded member comprises a rail along a length of the extruded member; and a mounting bracket configured to have a remote radio head (RRH) connected thereto, where a top side of the rail is configured to form a first portion of a hinge, where a top end of the mounting bracket is configured to form a second portion of the hinge, and where the top end of the mounting bracket is configured to be placed on the top side of the rail to form the hinge and the hinge is configured to allow the mounting bracket to be rotated down on the rail to a mounting location of the mounting bracket on the mount.

The mounting bracket may comprise a resilient snap-lock latch configured to lock the mounting bracket to the elongate extruded member at the mounting location. The resilient snap-lock latch may comprise a sheet metal spring fixedly attached to the mounting bracket and configured to engage a bottom end of the elongate extruded member. The rail may have a plurality of holes in a row along the top side of the rail, where the plurality of holes are configured to receive at least one of: one or more pins into at least one of the plurality of holes to limit horizontal movement of the mounting bracket on the rail, and one or more projections on the mounting bracket into at least one of the plurality of holes to limit horizontal movement of the mounting bracket on the rail. The rail may be configured to have a plurality of the mounting brackets connected thereto in a row with respective hinges being formed along the top side of the rail. The apparatus may further comprise a remote radio head (RRH) attached to the mounting bracket. The apparatus may further comprise a spring configured to engage a bottom end of the elongate extruded member to bias the mounting bracket towards the bottom end of the elongate extruded member. The top side of the rail may have a curved cross sectional shape with apertures into the top side, where the curved cross sectional shape of the top side forms a rotational surface of the first portion of the hinge. The rail may project from the elongate extruded member in a first direction and a bottom end of the elongate extruded member may comprise a second rail projecting in the first direction.

Referring also to FIG. 14, an example method may comprise: providing an elongate extruded member, where the elongate extruded member comprises a rail along a length of the extruded member, where the rail comprises a top side configured to form a first portion of a hinge as indicated by block 100; and providing a mounting bracket configured to have a remote radio head (RRH) connected thereto, where a top end of the mounting bracket is configured to form a second portion of the hinge as indicated by block 102, where the top end of the mounting bracket is configured to be placed on the top side of the rail to form the hinge and the hinge is configured to allow the mounting bracket to be rotated down on the top side of the rail to a mounting position of the mounting bracket on the mount as indicated by block 104.

The mounting bracket may be provided with a resilient snap-lock latch configured to lock the mounting bracket to the elongate extruded member at the mounting position. The resilient snap-lock latch may be provided as a sheet metal spring fixedly attached to the mounting bracket and configured to engage a bottom end of the elongate extruded member. The elongate extruded member may be provided having the rail with a plurality of holes in a row along the top side of the rail, where the plurality of holes are configured to receive at least one of: one or more pins into at least one of the plurality of holes to limit horizontal movement of the mounting bracket on the rail, and one or more projections on the mounting bracket into at least one of the plurality of holes to limit horizontal movement of the mounting bracket on the rail. The elongate extruded member may be provided having the rail configured to have a plurality of the mounting brackets connected thereto in a row with respective hinges being formed along the top side of the rail. The method may further comprise providing the mounting bracket with a remote radio head (RRH) attached to the mounting bracket. The method may further comprise providing the mounting bracket with a spring configured to engage a bottom end of the elongate extruded member to bias the mounting bracket towards the bottom end of the elongate extruded member. Providing the elongate extruded member may include the top side of the rail having a curved cross sectional shape with apertures into the top side, where the curved cross sectional shape of the top side forms a rotational surface of the first portion of the hinge. Providing the elongate extruded member may include the rail projecting from the elongate extruded member in a first direction and the elongate extruded member being provided with a bottom end comprising a second rail projecting in the first direction.

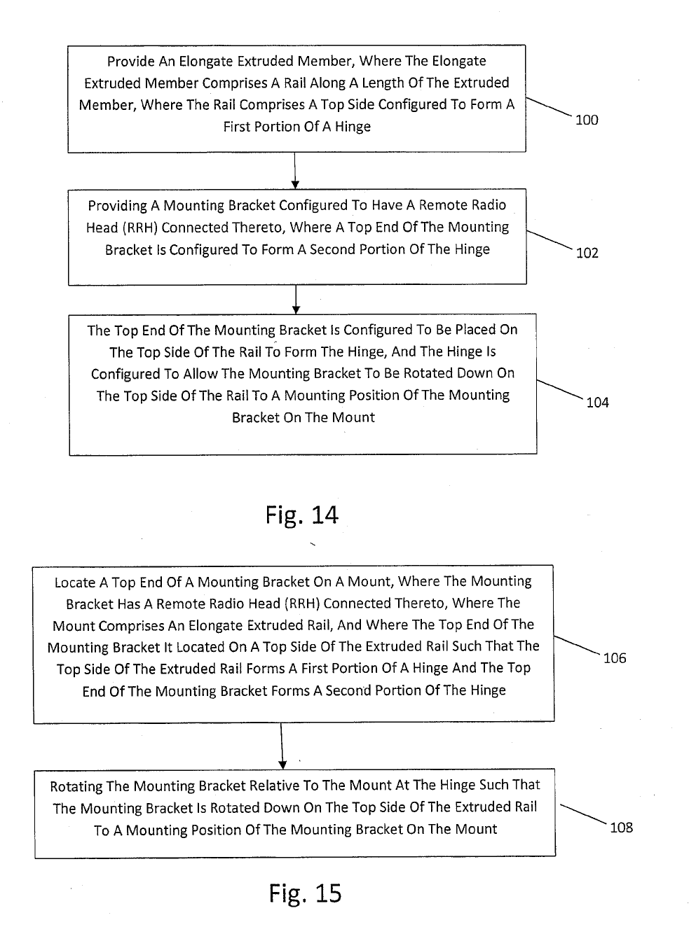

Referring also to FIG. 15, an example method may comprise locating a top end of a mounting bracket on a mount, where the mounting bracket has a remote radio head (RRH) connected thereto, where the mount comprises an elongate extruded rail, and where the top end of the mounting bracket it located on a top side of the extruded rail such that the top side of the extruded rail forms a first portion of a hinge and the top end of the mounting bracket forms a second portion of the hinge as indicated by block 106; and rotating the mounting bracket relative to the mount at the hinge such that the mounting bracket is rotated down on the top side of the extruded rail to a mounting position of the mounting bracket on the mount as indicated by block 108. The method may further comprise, upon rotating the mounting bracket relative to the mount at the hinge, resiliently snap-lock attaching the mounting bracket to a bottom rail on the elongate extruded member at the mounting position.

Another example embodiment may be provided in an apparatus comprising means for mounting to a frame structure comprising an elongate extruded member, where the elongate extruded member comprises a rail along a length of the extruded member; and means for mounting a remote radio head (RRH) to the means for mounting to the frame structure. A top side of the rail is configured to form a first portion of a hinge, where a top end of the means for mounting the remote radio head (RRH) is configured to form a second portion of the hinge, and the top end of the means for mounting the remote radio head (RRH) is configured to be placed on the top side of the rail to form the hinge and the hinge is configured to allow the means for mounting the remote radio head (RRH) to be rotated down on the rail to a mounting location of the means for mounting the remote radio head (RRH) on the means for mounting to the frame structure.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. A remote radio head (RRH) connection apparatus comprising:
a mount comprising an elongate extruded member, where the elongate extruded member comprises a rail along a length of the extruded member; and
a mounting bracket configured to have a remote radio head (RRH) connected thereto,
where a top side of the rail is configured to form a first portion of a hinge,
where a top end of the mounting bracket is configured to form a second portion of the hinge, and
where the top end of the mounting bracket is configured to be placed on the top side of the rail to form the hinge and the hinge is configured to allow the mounting bracket to be rotated down on the rail to a mounting location of the mounting bracket on the mount.

2. A remote radio head (RRH) connection apparatus as in claim 1 where the mounting bracket comprises a resilient snap-lock latch configured to lock the mounting bracket to the elongate extruded member at the mounting location.

3. A remote radio head (RRH) connection apparatus as in claim 2 where the resilient snap-lock latch comprises a sheet metal spring fixedly attached to the mounting bracket and configured to engage a bottom end of the elongate extruded member.

4. A remote radio head (RRH) connection apparatus as in claim 1 where the rail has a plurality of holes in a row along the top side of the rail, where the plurality of holes are configured to receive at least one of:
one or more pins into at least one of the plurality of holes to limit horizontal movement of the mounting bracket on the rail, and
one or more projections on the mounting bracket into at least one of the plurality of holes to limit horizontal movement of the mounting bracket on the rail.

5. A remote radio head (RRH) connection apparatus as in claim 1 where the rail is configured to have a plurality of the mounting brackets connected thereto in a row with respective hinges being formed along the top side of the rail.

6. A remote radio head (RRH) connection apparatus as in claim 1 further comprising a remote radio head (RRH) attached to the mounting bracket.

7. A remote radio head (RRH) connection apparatus as in claim 1 further comprising a spring configured to engage a bottom end of the elongate extruded member to bias the mounting bracket towards the bottom end of the elongate extruded member.

8. A remote radio head (RRH) connection apparatus as in claim 1 where the top side of the rail has a curved cross sectional shape with apertures into the top side, where the curved cross sectional shape of the top side forms a rotational surface of the first portion of the hinge.

9. A remote radio head (RRH) connection apparatus as in claim 1 where the rail projects from the elongate extruded member in a first direction and a bottom end of the elongate extruded member comprises second rail projecting in the first direction.

10. A method comprising:
providing an elongate extruded member, where the elongate extruded member comprises a rail along a length of the extruded member, where the rail comprises a top side configured to form a first portion of a hinge; and
providing a mounting bracket configured to have a remote radio head (RRH) connected thereto, where a top end of the mounting bracket is configured to form a second portion of the hinge,
where the top end of the mounting bracket is configured to be placed on the top side of the rail to form the hinge and the hinge is configured to allow the mounting bracket to be rotated down on the top side of the rail to a mounting position of the mounting bracket on the mount.

11. A method as in claim 10 where the mounting bracket is provided with a resilient snap-lock latch configured to lock the mounting bracket to the elongate extruded member at the mounting position.

12. A method as in claim 11 where the resilient snap-lock latch is provided as a sheet metal spring fixedly attached to the mounting bracket and configured to engage a bottom end of the elongate extruded member.

13. A method as in claim 10 where the elongate extruded member is provided having the rail with a plurality of holes in a row along the top side of the rail, where the plurality of holes are configured to receive at least one of:
one or more pins into at least one of the plurality of holes to limit horizontal movement of the mounting bracket on the rail, and
one or more projections on the mounting bracket into at least one of the plurality of holes to limit horizontal movement of the mounting bracket on the rail.

14. A method as in claim 10 where the elongate extruded member is provided having the rail configured to have a plurality of the mounting brackets connected thereto in a row with respective hinges being formed along the top side of the rail.

15. A method as in claim 10 further comprising providing the mounting bracket with a remote radio head (RRH) attached to the mounting bracket.

16. A method as in claim 10 further comprising providing the mounting bracket with a spring configured to engage a bottom end of the elongate extruded member to bias the mounting bracket towards the bottom end of the elongate extruded member.

17. A method as in claim 10 where providing the elongate extruded member includes the top side of the rail having a curved cross sectional shape with apertures into the top side, where the curved cross sectional shape of the top side forms a rotational surface of the first portion of the hinge.

18. A method as in claim 10 where providing the elongate extruded member includes the rail projecting from the elongate extruded member in a first direction and the elongate extruded member being provided with a bottom end comprising a second rail projecting in the first direction.

19. A method comprising:
locating a top end of a mounting bracket on a mount, where the mounting bracket has a remote radio head (RRH) connected thereto, where the mount comprises an elongate extruded rail, and where the top end of the mounting bracket it located on a top side of the extruded rail such that the top side of the extruded rail forms a first portion of a hinge and the top end of the mounting bracket forms a second portion of the hinge; and
rotating the mounting bracket relative to the mount at the hinge such that the mounting bracket is rotated down on the top side of the extruded rail to a mounting position of the mounting bracket on the mount.

20. A method as in claim 19 further comprising, upon rotating the mounting bracket relative to the mount at the hinge, resiliently snap-lock attaching the mounting bracket to a bottom rail on the elongate extruded member at the mounting position.
